(19) United States
(12) Patent Application Publication
(10) Pub. No.: US 2012/0241434 A1
(43) Pub. Date: Sep. 27, 2012

(54) ELECTRICAL POWER SUPPLY DEVICE FOR A RESISTOR ELEMENT, AND AN ELECTRICAL SYSTEM PROVIDED WITH SAID DEVICE AND SAID RESISTOR ELEMENT

(75) Inventors: André Amari, La Chapelle En Serval (FR); Daniel Brunner, Soisy-Sous-Montmorency (FR); Jacques Gaffiero, Paris (FR); Cédric Lanouette, Montrouge (FR)

(73) Assignee: EUROCOPTER, Marignane (FR)

(21) Appl. No.: 13/425,746

(22) Filed: Mar. 21, 2012

(30) Foreign Application Priority Data
Mar. 22, 2011 (FR) 11 00857

(51) Int. Cl. B23K 13/08; H01R 43/00; H05B 3/00

(52) U.S. Cl. 219/201; 219/482; 29/825

(57) ABSTRACT

An electrical power supply device (10) provided with electrically-conductive metal electrical connection means (12) secured to an electrical power supply wire (11), said connection means (12) comprising a first portion (13) connected to said power supply wire (11), followed by a second portion (14) that extends longitudinally and that is suitable for being permanently bonded to a resistor element (3) that is provided with a plurality of electrically-conductive layers (4). Said second portion (14) is tapering, presenting thickness (e) that decreases, starting from said first portion (13), said second portion (14) having at least one slot (15) passing through said second portion (14) in said direction in elevation.

### CROSS REFERENCE TO RELATED APPLICATIONS

This application claims priority to application no. FR 11 00857 filed on Mar. 22, 2011, the disclosure of which is incorporated in its entirety by reference herein.

### BACKGROUND OF THE INVENTION

(1) Field of the Invention

The present invention relates to an electrical power supply device for a resistor element, and to an electrical system provided with said device and said resistor element.

More particularly, the invention lies in the technical field of composite-material electrical heater mats for aircraft, which mats are used in example in the context of deicing and of anti-icing airfoil surfaces.

(2) Description of Related Art

The problem of airfoil surfaces icing is well-known in the aviation industry. The term “icing” is used to designate the more or less rapid formation of a deposit of ice on certain portions of the aircraft. Such a deposit of ice increases the weight of the aircraft, sometimes to a considerable extent, it spoils the flow of air by modifying the shape of the airfoil surface, and it thus greatly degrades the performance of the airfoil surface.

Furthermore, the term “anti-icing” designates preventing icing occurring.

This problem is often handled by fitting the airfoil surface with a heater mat. Such a heater mat has a resistor element provided with a plurality of layers of electrically-conductive fibers, each layer comprising a fabric of carbon fibers, for example. On passing an electric current, the resistor element acts by the Joule effect to heat the airfoil surface on which it is installed so as to deice it or so as to prevent it from icing.

In order to power the resistor element electrically, the heater mat is fitted with an electrical power supply device. In order to limit maintenance actions, the electrical power supply device must advantageously be securely connected to the resistor element, in particular so as to enable it to withstand fatigue stresses. Furthermore, it should be observed that conveying an electric current from the electrical power supply device to the resistor element sometimes gives rise to concentrations of current density.

The technological background includes several documents, and specifically it includes Document FR 2 867 011, Document WO 2006/077157, and Document U.S. Pat. No. 5,824,996.

For example, Document FR 2 867 011 describes an electrical power supply device for a resistor element. That electrical power supply device is provided with at least one metal plate connected to a power supply wire, the plate being provided with at least one connector member fastened to at least one layer of electrically-conductive fibers of the resistor element.

Document WO 2006/077157 describes an electrical power supply device for at least two carbon fabrics embedded in a material that is not electrically conductive.

Each fabric extends longitudinally from an end section, and each end section is in contact with an electrically-conductive material connected to an electrical conductor.

In order to optimize electrical resistance between each carbon fabric and said electrically-conductive material, the end sections are cut diagonally so as to maximize their surface areas.

It should be observed that in the context of a heater mat for heating the rotor blades of a rotorcraft, it would appear to be difficult to incorporate that technology. Indeed, it would appear to be difficult to cut non-polymerized fabrics diagonally.

Thereafter, since heater mats for blades made of composite materials are generally polymerized at the same time as the other members of the blade are polymerized, it would appear to be difficult to use the above suggestion in this context.

Document U.S. Pat. No. 5,824,996 suggests using a plate, the resistor element being folded around the plate.

Each of Documents U.S. Pat. No. 2,260,509, U.S. Pat. No. 2,260,365, U.S. Pat. No. 2,866,172, and U.S. Pat. No. 3,397,383 describes a receptacle having two plugs, each plug having a curved pin.

Those documents are thus far removed from the invention since they relate to electrical receptacles dedicated to separable contacts, and not to being secured to electrically-conductive layers of a resistor element.

Document BE 670 696 describes a coupling for an electric wire.

### BRIEF SUMMARY OF THE INVENTION

An object of the present invention is thus to propose an electrical power supply device suitable for being fastened strongly from a mechanical point of view to a resistor element, and at least to improve the progressive passage of electricity between the electrical power supply device and the resistor element.

According to the invention, an electrical power supply device is provided with electrically-conductive metal electrical connection means secured to an electrical power supply wire, the connection means comprising a first portion connected to the power supply wire, followed by a second portion that extends longitudinally and that is suitable for being permanently bonded to a resistor element that is provided with a plurality of electrically-conductive layers.

This electrical power supply device is remarkable in particular that the electrical connection means comprise a one-piece solid body provided with the first portion and with the second portion, and the second portion tapers, said second portion presenting thickness in a direction in elevation, which thickness decreases starting from the first portion and going towards a free end of the second portion, the second portion having at least one slot passing through the second portion in the direction in elevation.

It should be observed that the second portion extends in particular in elevation from a top face towards a bottom face that are distinct from each other.

The invention then comprises a second portion provided with a tapering solid body, the solid body being distinct from a curved blade and from the remote teaching of Document U.S. Pat. No. 2,260,509, in particular.

The second portion may then be a cylinder obtained using a generator line passing through a varying point that describes a tapering shape such as a triangle. A longitudinal section of the second portion may be triangular in shape.

As a result, the electrical resistance of the second portion decreases so as to minimize any risk of hot points arising.

Furthermore, each electrically conductive layer is caused to co-operate with a slot. Under such circumstances, this engagement of the electrically conductive layers encourages attachment of the electrically conductive layers to the electrical power supply device.

Furthermore, the electrical power supply device may include one or more of the following additional characteristics.

For example, the second portion may present a top face and a bottom face that are smooth and suitable for being fastened to a resistor element, the bottom face and the top face being pierced in order to present the slot(s) of the electrical power supply device.

Roughnesses on a face represent attachment points that are advantageous from a mechanical strength point of view. Nevertheless, such roughnesses may generate points that constitute preferred flow paths for electricity that can, in the extreme, give rise to hot points that might damage the device and reduce its lifetime.

At least one of the bottom and top faces optionally presents chemical surface treatment for cleaning, in order to be smooth.

Furthermore, at least one of the bottom and top faces optionally presents a primary adhesion layer. The electrically conductive layers may possess an impregnation resin. However, impregnation resins are sometimes not very adhesive. Under such circumstances, the primary adhesion layer enhances the fastening of the electrical power supply device to the resistor element.

In another aspect, the connection means include nickel 201. Surprisingly, this material is electrically conductive while allowing a power supply wire to be soldered onto the first portion. Furthermore, this material presents an acceptable compromise in terms of chemical stability and it enables the electrically-conductive layers to adhere in acceptable manner, in particular when they are based on pre-impregnated carbon fibers.

Furthermore, the thickness decreases from a thickness of 0.5 millimeters (mm) to a thickness of 0.1 mm, with the second portion extending longitudinally over a length lying in the range 30 mm to 40 mm.

Also, the second portion may optionally be symmetrical, with a top face and a bottom face that are symmetrical about a midplane, said midplane being defined by longitudinal and transverse directions that are orthogonal to the axis in elevation.

In addition to an electrical power supply device, the invention also provides an electrical system such as a heater mat.

This electrical system is provided with a resistor element comprising a plurality of layers of electrically-conductive fibers that are superposed in a direction in elevation, each layer extending in a transverse direction and in a longitudinal direction, the resistor element being in contact with an electrical power supply device provided with electrically-conductive metal electrical connection means secured to an electrical power supply wire, the connection means having a first portion connected to the power supply wire followed by a second portion extending longitudinally and connected to the resistor element, each of said layers adhering in non-removable manner to said second portion.

This electrical system is remarkable in particular in that the fastener device is a device according to the invention, the second portion being tapered, said second portion presenting a thickness in a direction in elevation, the thickness decreasing from the first portion going towards a free end of the second portion, the second portion having at least one slot passing through the second portion in the direction in elevation.

Furthermore, this electrical system may possess one or more of the following characteristics.

For example, each layer may extend longitudinally from a connection zone, each connection zone extending in elevation between two contact surfaces, and a contact surface of each layer may be secured longitudinally and directly to the second portion by being in contact with a face of the second portion and by penetrating into the slot.

Thus, the invention proposes causing each electrically conductive layer to be bonded to the second portion of the electrical power supply device via a contact surface, and not via an end section, where the end section is specifically the section connecting together in elevation the two contact surfaces at the end of the layer.

Electricity is then transferred between a layer of electrically conductive fibers and the second portion via the connection zone of large area, and not via a point at an end section.

Furthermore, this contact surface is arranged longitudinally on the second portion, with the thickness of the second portion tapering in said longitudinal direction. As a result the electric current flow is distributed effectively from the second portion to each layer of electrically conductive fibers, with this distribution minimizing any risk of a current concentration zone appearing.

Furthermore, the second portion may be embedded in the resistor element, each connection zone of a first group of layers of electrically-conductive fibers being fastened to a top face of the second portion, and each connection zone of a second group of fabrics being fastened to a bottom face of the second portion.

In another aspect, the invention provides a blade including an electrical heater system, which system is of the type presented above.

Furthermore, the invention provides a method of fabricating an electrical system, the method comprising the steps of:

fabricating metal connection means comprising a first portion followed by a second portion extending longitudinally, the second portion tapering and presenting a thickness that decreases in a direction in elevation going away from the first portion, at least one slot being formed in the second portion to pass through the second portion in the direction in elevation;

draping the layers of electrically conductive fibers of a resistor element, each layer of electrically conductive fibers having a connection zone extending in elevation between two contact surfaces, a contact surface of each contacting connection zone being placed on the second portion;

polymerizing the assembly comprising the layers of electrically-conductive fibers and the connection means; and

fastening an electrical power supply wire to the first portion.

This method then enables electric current to pass progressively between the metal connection means and the resistor element.

Furthermore, the electrical resistance of the second portion is degressive so as to minimize, surprisingly, the risk of hot points appearing.

The method also serves to optimize the connection of the electrically-conductive layers on the metal connection means.

### BRIEF DESCRIPTION OF THE SEVERAL VIEWS OF THE DRAWINGS

The invention and its advantages appear in greater detail from the following description of embodiments given by way of illustration with reference to the accompanying figures, in which:

FIG. 1 is a view of an electrical power supply device of the invention;

FIG. 2 is a diagrammatic view of a first embodiment of an electrical system of the invention;

FIG. 3 is a section view of said first embodiment;

FIG. 4 is a diagrammatic view of a second embodiment of an electrical system of the invention; and

FIG. 5 is a flowchart explaining the method that is implemented.

Elements that are present in more than one of the figures are given the same references in each of them.

### DETAILED DESCRIPTION OF THE INVENTION

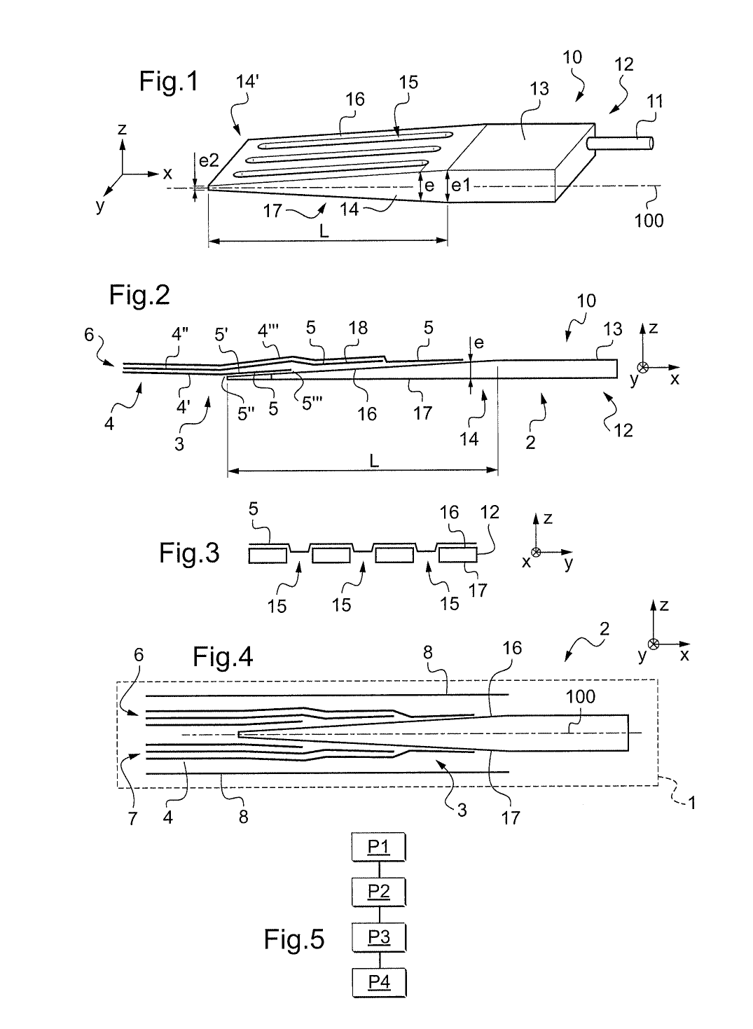

It should be observed that three mutually orthogonal axes X, Y, and Z are shown in FIGS. 1 to 4.

The first axis X is said to be “longitudinal”. The term “longitudinal” relates to any direction parallel to the first axis X.

The second axis Y is said to be “transverse”. The term “transverse” relates to any direction parallel to the second axis Y.

Finally, the third axis Z is said to be “in elevation”. The term “in elevation” relates to any direction parallel to the third axis Z.

FIG. 1 shows an electrical power supply device 10 provided with an electrical power supply wire 11 and with connection means 12 for feeding a resistor element electrically.

The connection means 12 may then comprise a first portion 13 for connecting electrically to the power supply wire 11 and a second portion 14 for connecting electrically to a resistor element.

Thus, in the example shown, the power supply wire 11 is electrically connected to the top face of the first portion 13, possibly by soldering, by welding, or by any other mechanical means such as crimping, riveting, screw fastening, or adhesive bonding using an electrically-conductive adhesive.

Furthermore, in elevation, the second portion 14 presents successively a top face 16 and a bottom face 17 extending both longitudinally and transversely. The thickness e of the second portion 14 is then arranged in a direction in elevation, representing the distance between the top face 16 and the bottom face 17 along the elevation axis.

The second portion advantageously tapers. Thereafter, starting from the end of the second portion 14 that is fastened to the first portion 13, and going towards the free end 14′ of the second portion 14, the thickness e of the second portion 14 diminishes.

For example, in a variant, the thickness e diminishes from the first portion 13 where it has a thickness e1 equal to 0.5 mm to a thickness e2 equal to 0.1 mm, the second portion extending longitudinally over a length L lying in the range 30 mm to 40 mm.

The connection means may be fabricated using an electrically-conductive metal material, suitable for being soldered to a power supply wire, having characteristics, in particular chemical stability characteristics that are compatible with carbon fibers. Advantageously, the connection means may then be made using metals that are alloyed to a greater or lesser extent and based on nickel, copper, zinc, and silver.

Furthermore, the top face 16 and/or the bottom face 17 for coming into contact with the layers of electrically-conductive fibers are optionally smooth. To this end, the top face 16 and/or the bottom face can present a chemical surface treatment for cleaning.

Furthermore, the top face 16 and/or the bottom face 17 may present a primary adhesion layer 18, e.g. based on epoxy resin that is applied after performing surface treatment of the type comprising chemical etching by means of an acid.

In another aspect, in a variant of FIG. 1, the second portion 14 is symmetrical about a midplane 100, the top face 16 and the bottom face 17 being symmetrical about the midplane 100. The midplane is defined by a longitudinal direction and by a transverse direction that are orthogonal to said axis in elevation.

In another aspect, the second portion 14 includes at least one slot 15 passing through the second portion 14 along a direction in elevation, each slot then passing through the second portion by going from the top face 16 towards the bottom face 17. Each slot may be a hole that is oblong in elevation, extending longitudinally so as to be directed in the direction that is followed by the fibers of the electrically-conductive layers fastened to the second portion 14.

FIG. 2 shows an electrical system 1 having a resistor element 3 and an electrical power supply device 10 including connection means 12.

The resistor element 3 comprises a plurality of layers 4 of electrically-conductive fibers that are superposed in a direction in elevation. By way of example, each layer is provided with pre-impregnated carbon fibers extending in a longitudinal direction, i.e. in a direction in which the second portion 14 of the fastener means 12 extend, and in particular in which the slots 15 in the second portion 14 extend.

Each layer 4 extends more particularly longitudinally from a connection zone towards a distal zone. Each connection zone 5 then possesses a contact surface 5′, 5″ that is secured longitudinally and directly to the second portion 14 by being in contact with a face of said second portion 14.

The layers 4′, 4″, 4′ of the resistor element also present different lengths so as to be arranged on said second portion in a staircase arrangement.

The arrangement of the second portion of tapering thickness of the connection means 12 and of the successive layers 4′, 4″, 4′ of differing lengths makes it possible to organize an assembly that does not present any local extra thickness. In this respect, if the total thickness of the layers 4 of the resistive element is greater than the thickness of the first portion 13 of the connection means 12, then only a few of the layers 4′ are cut. It suffices for the first portion 13 to remain accessible to ensure that mechanical and electrical connection is made with the power supply wire 11.

Under such circumstances, a first layer 4′ includes a connection zone 5 that is defined in elevation by a top contact surface 5′ and by a bottom contact surface 5″. The connection zone is then in contact with the free end of the top face 16 of the second portion via its bottom contact surface 5″, and not via its end section 5′″.

The same applies for a second layer 4″ superposed on the first layer 4′. Nevertheless, it should be observed that the second layer 4″ presents a length that is greater than the length of the first layer 4′ so as to be in contact with an intermediate segment of the top face 16.

Finally, a third layer 4′″ superposed on the second layer 4″ possesses a length greater than the length of the second layer 4″ so as to be in contact with a proximal segment of the second portion 14 adjacent to the first portion 13.

Each layer of electrically-conductive fibers presents a substantial contact zone with the second portion in order to optimize the distribution of electric current within the resistor element, thereby minimizing any risk of overheating.

Furthermore, the resultant electrical resistance as calculated from the electrical resistance of the connection means 12 and the electrical resistance of the fibers of the resistor element decreases going towards the second portion 14, starting from the first portion 13. This resulting variation in electrical resistance that is progressive and continuous makes it possible to minimize any risk of overheating.

Furthermore, this arrangement optimizes the mechanical strength of the electrical system, in particular in terms of fatigue, by avoiding any sudden changes in working section.

It should be observed that the space occupied by the electrical power supply device is advantageously contained within the space occupied by the resistor element.

In another aspect, with reference to FIG. 3, each connection zone of a layer of electrically-conductive fibers penetrates in part into the slots 15 so as to optimize the mechanical anchoring of the layers 4 on the second portion 14.

With reference to FIG. 2, in the first embodiment, the resistor element 3 comprises a single group 6 of layers 4 of electrically-conductive fibers fastened to a single face of the second portion 14.

FIG. 4 shows a blade 1 having an electrical system in a preferred, second embodiment.

In this second embodiment, the second portion 14 is embedded in the resistor element 3. Each connection zone 5 of a first group 6 of layers of electrically-conductive fibers is fastened to a top face 16 of the second portion 14, and each connection zone 5 of a second group 7 of layers of electrically-conductive fibers is fastened to a bottom face 17 of the second portion 14.

It should be observed that the electrical system 3 may also include layers of glass fibers 8 on either side of the resistor element.

FIG. 5 explains a method of fabricating such a blade 1.

During a first step P1, metal connection means 12 of the invention are fabricated.

Under such circumstances, during a second step P2, the layers 4 of electrically-conductive fibers of a resistor element 3 are draped, each layer 4 having a connection zone that extends in elevation between two contact surfaces 5′, 5″, one contact surface 5′, 5″ of each connection zone 5 being placed on the first portion 14 of the connection means 12.

For example, the layers of a first group of layers of electrically-conductive fibers are draped, and then the layers of a second group of layers of electrically-conductive fibers are draped on either side of the second portion.

In parallel, the zone of the first portion onto which the power supply wire 11 is to be connected is protected by an anti-adhesive coating, e.g. Teflon® tape. Thereafter, it is possible to cover the assembly comprising the layers 4 of electrically-conductive fibers and the connection means 12 with glass fibers, for example.

During a third step P3, the assembly comprising the layers 4 of electrically-conductive fibers and the connection means 12 is polymerized.

Finally, during a step P4, an electrical power supply wire 11 is fastened to the first portion 13.

If an anti-adhesive coating has been placed on the first portion during the second step, then the anti-adhesive coating is removed. The power supply wire 11 may then be connected to the first portion 13, e.g. by soldering.

If necessary, the electrical power supply wire 11 is connected to the first portion 13 before the electrical system is polymerized.

It should be observed that during the second step, it is possible to place the various members of the blade 1 around the assembly comprising the layers 4 of electrically conductive fibers and the connection means 12. Thus, during the third step, the blade fitted with its electrical system 3, specifically a heater mat, is polymerized.

Naturally, the present invention may be subjected to numerous variations as to its implementation. Although several embodiments are described above, it should readily be understood that it is not conceivable to identify exhaustively all possible embodiments. It is naturally possible to envisage replacing any of the means described by equivalent means without going beyond the ambit of the present invention.

What is claimed is:

1. An electrical power supply device provided with electrically-conductive metal electrical connection means secured to an electrical power supply wire, said connection means comprising a first portion connected to said power supply wire, followed by a second portion that extends longitudinally and that is suitable for being permanently bonded to a resistor element provided with a plurality of electrically-conductive layers, wherein the electrical connection means comprise a one-piece solid body provided with the first portion and with the second portion, and said second portion tapers, said second portion presenting thickness (e) in a direction in elevation, which thickness (e) decreases starting from said first portion and going towards a free end of the second portion, said second portion having at least one slot passing through said second portion in said direction in elevation.

2. A device according to claim 1, wherein said second portion presents a top face and a bottom face that are smooth and suitable for being fastened to a resistor element, and the top face and the bottom face are pierced in order to present said slot.

3. A device according to claim 2, wherein at least one of said top and bottom faces presents chemical surface treatment for cleaning.

4. A device according to claim 2, wherein at least one of said top and bottom faces presents a primary adhesion layer.

5. A device according to claim 1, wherein said connection means include nickel 201.

6. A device according to claim 1, wherein said thickness (e) decreases from a thickness of 0.5 mm to a thickness of 0.1 mm, with said second portion extending longitudinally over a length (L) lying in the range 30 mm to 40 mm.

7. A device according to claim 1, wherein said second portion is symmetrical, with a top face and a bottom face that are symmetrical about a midplane, said midplane being defined by longitudinal and transverse directions that are orthogonal to said axis in elevation.

8. An electrical system provided with a resistor element comprising a plurality of layers of electrically-conductive fibers that are superposed in a direction in elevation, each layer extending in a transverse direction and in a longitudinal direction, said resistor element being in contact with an electrical power supply device provided with electrically-conductive metal electrical connection means secured to an electrical power supply wire, the connection means having a first portion connected to said power supply wire followed by a second portion extending longitudinally and connected to said resistor element; wherein said fastener device is a device according to claim 1, said second portion being tapered, said second portion presenting a thickness (e) in a direction in elevation, said thickness (e) decreasing from said first portion going towards a free end of the second portion, said second portion having at least one slot passing through said second portion in said direction in elevation, each of said layers adhering in non-removable manner to said second portion.

9. An electrical system according to claim 8, wherein each layer extends longitudinally from a connection zone, and a contact surface of each layer is secured longitudinally and directly to the second portion by being in contact with a face of said second portion and by penetrating into said slot.

10. An electrical system according to claim 8, wherein said second portion is embedded in said resistor element, each connection zone of a first group of layers of electrically-conductive fibers being fastened to a top face of said second portion, and each connection zone of a second group of layers of electrically-conductive fibers being fastened to a bottom face of said second portion.

11. A blade provided with an electrical heater system, wherein said electrical system is a system according to claim 8.

12. A method of fabricating an electrical system according to claim 8, characterized by the following steps:
fabricating metal connection means comprising a first portion followed by a second portion extending longitudinally, said second portion (14) tapering and presenting a thickness that decreases in a direction in elevation going away from said first portion, at least one slot being formed in said second portion to pass through said second portion in said direction in elevation;
draping the layers of electrically conductive fibers of a resistor element, each layer having a connection zone extending in elevation between two contact surfaces, a contact surface of each connection zone being placed on said second portion;
polymerizing the assembly comprising said layers of electrically-conductive fibers and said connection means; and
fastening an electrical power supply wire to said first portion.
